(19) United States
(12) Patent Application Publication
(10) Pub. No.: US 2022/0232786 A1
(43) Pub. Date: Jul. 28, 2022

(54) Improved Automated Horticulture System

(71) Applicants: Robert W. Noble, Murrysville, PA (US); Robert P. Noble, Murrysville, PA (US)

(72) Inventors: Robert W. Noble, Murrysville, PA (US); Robert P. Noble, Murrysville, PA (US)

(21) Appl. No.: 17/617,678

(22) PCT Filed: Jun. 12, 2020
(86) PCT No.: PCT/US2020/037563

§ 371 Date: Dec. 9, 2021

Related U.S. Application Data
(60) Provisional application No. 62/860,673, filed on Jun. 12, 2019.

(51) Int. Cl. A01G 31/06

(52) U.S. Cl. CPC A01G 31/06

(57) ABSTRACT

A horticulture system comprises a reservoir, a growing array comprising a plurality of modular growing chambers, a sprayer system, and a drip system. Each said growing chamber comprises a suspension chamber with an opening to receive a plant container and an attachment member above the opening for the mounting of drip nozzles from the drip system. A growth channel located beneath the suspension chamber having a first end connected to an endcap or an upstream growing chamber, at least one opening for the insertion of one sprayer heads from the sprayer system, a cavity for the containment of plant roots, and a second end connected to a drain or a downstream growing chamber. There is a negative slope from the first end to the second end for the discharge of runoff water from the drip system and the sprayer system.

### BACKGROUND

Hydroponic gardening is the growing of plants in nutrient solutions with or without an inert medium to provide mechanical support for the plant. When grown hydroponically, plants flourish in a manner superior to the way they are grown in a normal soil medium. This is because the plants do not have to push through soil to develop their expansive root systems to absorb necessary nutrients. These nutrients are also more bio-available to the plants when not in dirt. With hydroponic growing techniques, plants begin growth very quickly and grow faster than they would in a soil medium causing them to ripen earlier. There are many types of systems that fall under hydroponic growing. One technique termed Aeroponics has been developed in which the plant roots, instead of being suspended in a nutrient solution, are suspended in air while a fine mist of nutrient solution is sprayed onto them. Another technique called Nutrient Film Technique (“NFT”) is a hydroponic technique that uses a very shallow stream of water, containing all the dissolved nutrients required for plant growth, and re-circulates the water past the bare roots of plants in a watertight gully, also known as a channel. Drip Irrigation is a form of hydroponics that drips water to the roots maximizing air flow in chambers while allowing the roots to receive a consistent supply of water and nutrients. Until the system described herein was developed, no one has been able to effectively combine these hydroponic techniques into one system.

### SUMMARY

What is presented is a horticulture system that comprises a reservoir containing water and a growing array that comprises a plurality of modular growing chambers arranged in sequence in at least one row. A sprayer system comprising at least one sprayer head delivers water from the reservoir to each growing chamber. A drip system comprising at least one drip nozzle delivers water from the reservoir to each said growing chamber. Each growing chamber further comprises a suspension chamber with an opening to receive a plant and an attachment member above the opening for the mounting of one of the drip nozzles from the drip system. A growth channel is located beneath the suspension chamber having a first end connected to an endcap or an upstream growing chamber, at least one opening for the insertion of one of the sprayer heads from the sprayer system, a cavity for the containment of plant roots, and a second end connected to a drain or a downstream growing chamber. There is a negative slope from the first end to the second end for the discharge of runoff water from the drip system and the sprayer system. Adjustable support racks could be used set the slope of the growing chambers of the growing array. The drain returns the runoff water from said drip system and said sprayer system to said reservoir. The sprayer heads create a mist of water within the growth channel. The horticulture system could comprise more than one growing array connected to the water reservoir.

An access door may be located on the growth chamber to access the cavity. The number of openings for the insertion of sprayer heads from the sprayer system can also be varied. In some embodiments, the growth channel having at least two openings for the insertion of sprayer heads from the sprayer system. Some crops would require a flush tank to be connected to the growing array. A supplemental energy source could also be connected to the horticulture system. The plant container could have a growing medium for the growth of contained plants.

The horticulture system may include a treatment system connected to the reservoir. In such embodiments, the drain returns the runoff water from the drip system and the sprayer system to the treatment system before it is returned to the reservoir. The treatment system could be an ozone treatment system, a UV treatment system, a filtration system, or other water treatment system.

Oxygen could be added to the water in the horticulture system by one of sprayers, oxygen stones, oxygen tanks, a pump adding ambient air to said reservoir, or other means. A nutrient injector could be connected to the reservoir for the addition of nutrients to the water. A blower may be connected to the endcap for the provision of additional airflow through the growing array. Each row of the growing array could have a pressure regulator for independent control of the sprayer system and a pressure regulator for independent control of the drip system. Each said sprayer head and each drip nozzle could also be equipped with a shutoff valve. A return pump could be located downstream of the growing array to return runoff water to the reservoir. Sensors could be incorporated at various locations in the horticulture system to monitor the chemical and/or environmental conditions of the water and the growing chambers.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a schematic of a horticulture system disclosed herein;

FIG. 2 is a variation of a horticulture system having several growing arrays and controlled by a network of sensors;

FIG. 3 is perspective view of a modular growth chamber;

FIG. 4 is an exploded view of a modular growth chamber of FIG. 3 installed in a growth array;

FIG. 5 is another exploded view of a modular growth chamber of FIG. 4;

FIG. 6 is a perspective view of a row of modular growth chambers of FIG. 3;

FIG. 7 is a top view of a horticulture system comprising a growing array of modular growth chambers of FIG. 3;

FIG. 8 is a perspective view of the horticulture system of FIG. 8; and

FIG. 9 is a perspective view of another horticulture system having a different growing array of modular growth chambers.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

The embodiments disclosed herein overcome the shortcomings of prior art horticulture systems and apparatuses by combining the strengths of Aeroponic, NFT, and drip irrigation systems. It is a fully automated farming system designed to maximize efficiency and consistency in personal and commercial settings.

The system presented has various systems and sub-systems that work in unison to produce quality plants consistently and efficiently. Within the various systems there are alterations, adaptations, and advancements of previous technologies and devices.

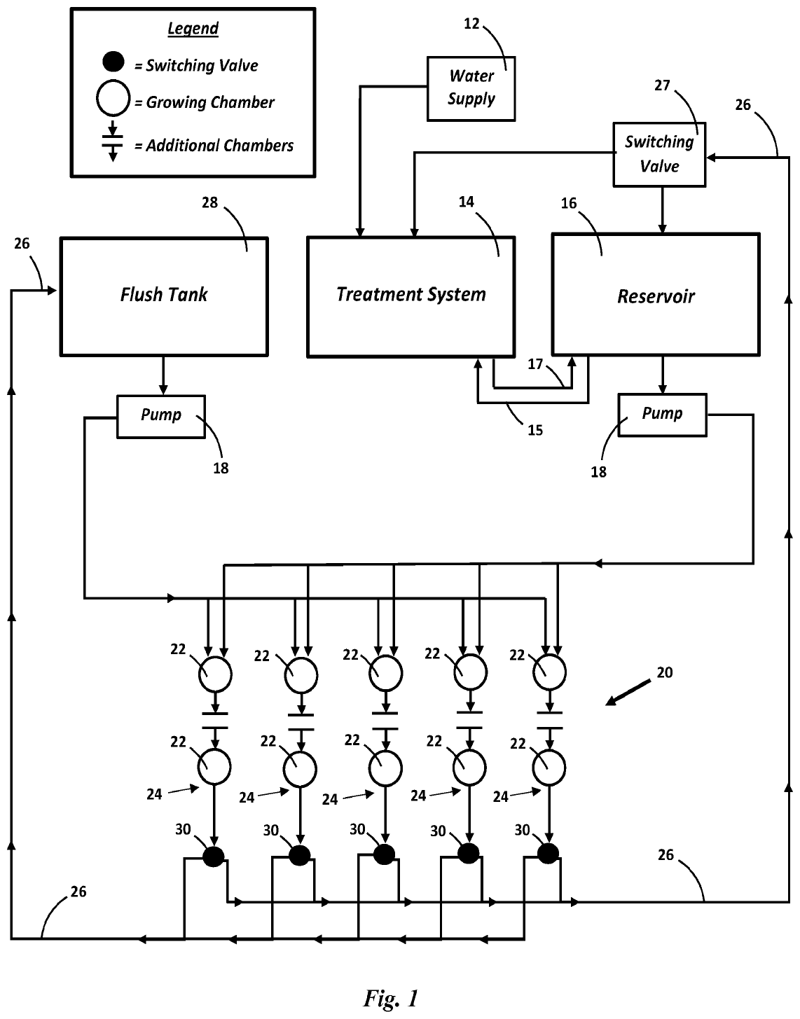

FIG. 1 shows a schematic of the horticulture system 10 presented herein. Water is added to the horticulture system 10 from water source 12. This water may be treated or filtered outside the horticulture system 10 system as needed. This could be by one or more of reverse osmosis, ultraviolet (“UV”) light, sand or other filters, or by any other means. Whether or not the water is so treated, it is fed to a treatment system 14 before it is fed to a reservoir 16. This ensures that the water in the horticulture system 10 is as free of contaminants as possible.

The treatment system 14 is preferably an ozone system, however, any system that purifies the water of algae, bacteria, or other pathogens would be acceptable. Ozone systems are preferred as they also oxygenate the water. The treatment system 14 essentially refreshes the water thus allowing the horticulture system 10 to continue cycling the water longer before replacing it if that is even necessary.

After treatment, the water is transferred into the reservoir 16. In the reservoir 16 the nutrients, pH, oxygen, conductivity, and any other parameters of the water can be adjusted and monitored by sensors (not shown). While in the reservoir 16 a pump continuously pumps the water through a sand filter. Also, while in the reservoir 16 the water can be oxygenated by sprayers, oxygen stone, or other methods. This oxygen can be provided by an oxygen machine or a pump using ambient air. The preferred method would be an oxygen machine. This supplement oxygen could also be used as an oxygen source for the treatment system 14—this is particularly useful if the treatment system 14 is an ozone system. Nutrients can also be added to the water in the reservoir 16. An agitator which could be a mixer or an aerator (not shown) located in the reservoir 16 keeps nutrients evenly mixed as well as further oxygenating the water. This is important to keep the water fresh and consistent throughout the horticulture system 10. Water in the reservoir 16 may be periodically diverted to the treatment system 14 as needed to control algae, bacteria, or other pathogens and then returned to the reservoir 16.

Pumps 18 in or connected to the reservoir 16 direct water to a growing array 20 that is the primary plant growth system. These pumps 18 pump water from the reservoir 16 to a sprayer system (example: high pressure pump for misters/foggers) and a drip irrigation system (“DIS”) which are associated with the growing array 20 and will be discussed in further detail below. The growing array 20 is located in a grow room or a greenhouse. The growing array 20 and the reservoir 16 and treatment system 14 may be located in different rooms or may be in the same room. The pumps 18 in the system would be sized appropriately for the pressure conditions required for the operation of the horticulture system 10.

The environment in the grow room is not part of the horticulture system 10 disclosed since the horticulture system 10 can be placed in an outdoor setting or an indoor setting, but the environment does directly impact the quality and quantity of whatever is grown in the horticulture system 10. Certain aspects, such as the plant's ability to absorb CO₂, may be amplified using this system as well.

The grow room may have supplemental lighting that includes height adjustable lights suspended above the growing array 14. Various types of lighting may be used based on types of plants, plant growth stage and preference. Different types of lighting may require slight modifications in system set-ups.

The grow room may also require duct work for heating and/or cooling. Air would be circulated by intake and exhaust systems which would also filter the fresh air coming in. Supplemental CO₂ may be added by CO₂ systems. Ozone for air purification can be added by an Ozone system or from the water treatment 14 system if that includes an ozone system.

As described in further detail below, the growing array 20 comprises a plurality of growing chambers 22 arranged in sequence in at least one row 24. FIG. 1 shows a growing array 20 of five rows 24 and only shows two growing chambers 22 in each row 24, but it will be understood that the number of growing chambers 22 may be varied by the application. Water from the reservoir 16 is directed to each row 24 of growing chambers 22 in the growing array 20.

Each row 24 ends in a drain 26 from which excess water either flows by gravity or is pumped back to the reservoir 16. The water from the drain 26 can be returned to a holding tank (not shown), the treatment system 14, or directly to the reservoir 16, as needed. The purpose of a holding tank, if used, would be monitored and treat the water quality before returning it to the reservoir 16. The water can be rerouted to the treatment system 14 instead of the reservoir 16 at any time via switching valve 27 to treat and purify the water. Water may also be sent between the reservoir 16 the treatment system 14 via the treatment fluid passage 15 and the reservoir fluid passage 17. The ozone gas produced from the ozonized water can be vented to the grow room to kill airborne bacteria/pathogens or it can be vented outdoors where it is naturally occurring. FIG. 1 also shows the presence of a flush tank 28. Some plants require flushing prior to harvesting to improve product quality. In such instances, valves 30 may be incorporated to direct water flow back to the flush tank 28.

Each row 24 of the growing array 22 may be individually controlled and/or turned on or off or rerouted as needed. This would allow plants to be grown at different stages in the same room creating a perpetual growth and harvest cycle and easier management during harvest. For example, if a first row 24 would be ready to harvest in the tenth week, the second row 24 would be ready the following week, and so on. When a row 24 is harvested, a new crop of plants would replace the harvested crop thereby restarting the cycle.

All nutrient water pumped through the horticulture system 10 should at some point go through a chilling system (not shown) which could be a water chiller, an underground system, or an underwater system. This would help prevent any harmful bacteria/pathogens from growing. This also makes the nutrient solution more bioavailable to the plants roots and keeps the pumps cool which helps them last longer.

Various filters may be placed throughout the horticulture system 10 to prevent clogs and keep the water clean (examples: sand filters, whole house water filters, etc.). When the water goes through the horticulture system 10 it is returned to the reservoir 16 (example: by gravity flow, by pumps, etc.). As discussed, water may be returned to multiple locations, such as a holding tank (not shown), the treatment system 14, or directly to the reservoir 16, as needed. Automatic or manual shut-off valves can be incorporated throughout the horticulture system 10 to re-route water as desired.

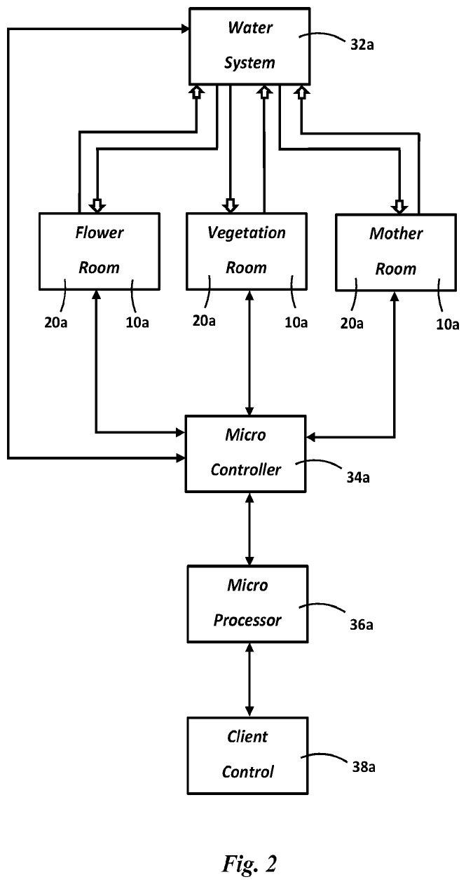

The entire horticulture system 10 can be run manually but is meant to be run by a computer that monitors and controls every aspect from start to harvest. FIG. 2 shows an application of the horticulture system 10a in which the components that handle and process the water in the horticulture system 10a, collectively indicated as the water system 32a, serve three separate growing arrays 20a, each in different rooms for different stages of plant life. Water flow throughout the horticulture system 10a can be controlled by inline automated solenoids. Sensors and monitors can be placed throughout the horticulture system 10 to measure temperature, humidity, CO₂ and O₂ levels, ventilation, and the operation of various components. In addition, water quality sensors can measure nutrients, pH, oxygen, conductivity, and any other parameters of the water. All of the readings from these sensors and monitors and controllers can be routed to a microcontroller 34a that could be as simple as an Arduino device. The micro controller 34a routes the readings to a microprocessor 36a which could be a simple Raspberry Pi or a personal computer or other device. Readings from the microprocessor 36a are routed to a client control interface 38a where a user can review the readings from the monitors and sensor and provide instructions to control each of the elements of the horticulture system 10a.

Climate (Ventilation, CO2, Temperature, & Humidity) is controlled by automated greenhouse monitor/controllers. The water treatment systems would be controlled by their own monitor and control systems. Photoperiods are automatically controlled as well as light levels. Electricity can be generated by solar panels, bought, or both. Each growing array 20a can be monitored or controlled for parameters such as water output, clogs in sprayer and drip systems, oxygen levels, or even bacteria or pathogens levels and nutrients levels in the water. Individualizing the nutrient ratio per plant site through injectors or some other method will also be controllable through the software. The software can track the life of the entire system and its parts to inform the user when something needs replaced or maintenance needs performed.

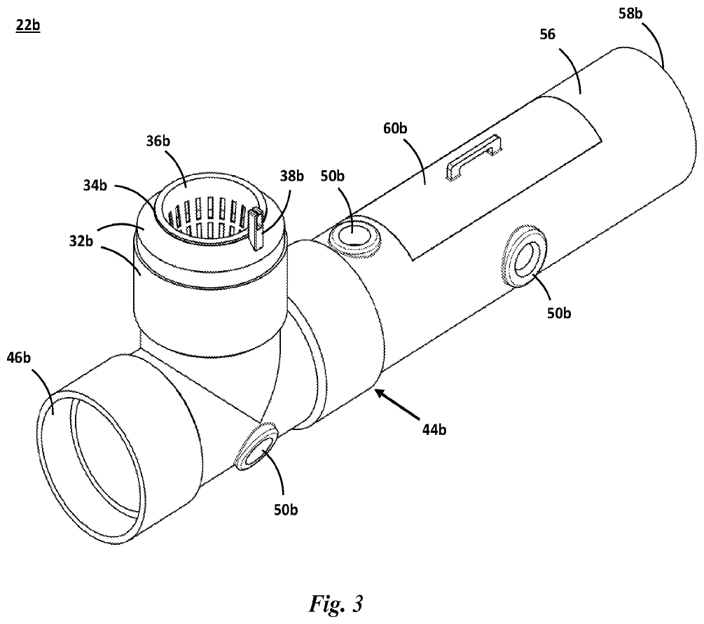

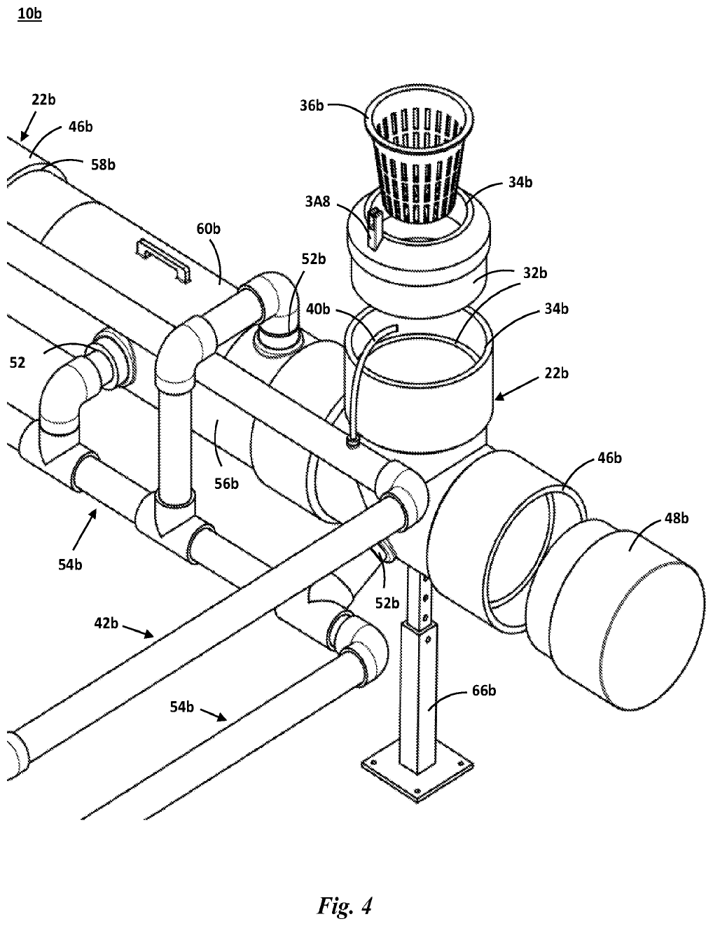

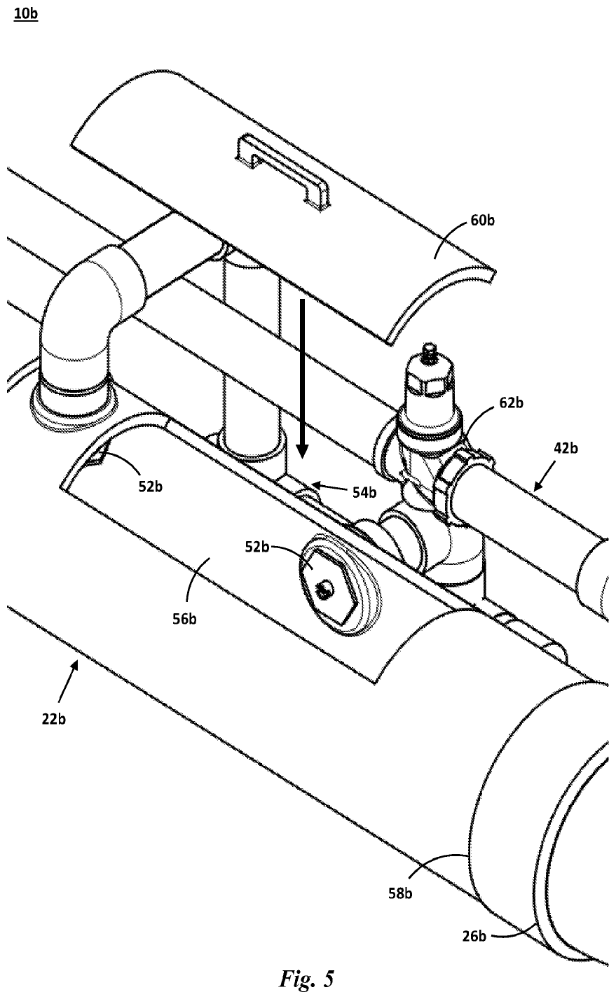

FIG. 3 shows an individual growing chamber 22b and its components and FIGS. 4 and 5 show an exploded views of the growing chamber 22b installed in a row 24b of a growing array 20b. As best understood by comparing FIGS. 3, 4, and 5, the growing chamber 22b comprises a suspension chamber 32b with an opening 34b to receive a plant container 36b that holds a plant to be grown in the growing chamber 22b. The plant container 36b may have a growing medium designed for the growth of contained plants. An attachment member 38b is located above the opening 34b for mounting a drip nozzle 40b from a drip system 42b (discussed in more detail later).

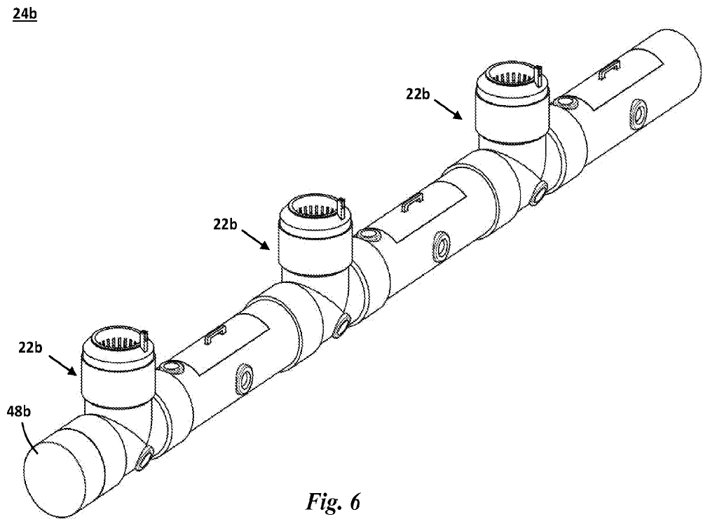

A growth channel 44b located beneath the suspension chamber 32b has a first end 46b connected to either an endcap 48b or an upstream growing chamber. At least one opening 50b is provided for the insertion of sprayer heads 52b from a sprayer system 54b (discussed in more detail later). In the embodiment shown in the figures, the growth chamber 22b has three openings 50b that each receive a sprayer head 52b. A cavity 56b extends through the growth channel 44b for the containment of plant roots. The growth channel 44b has a second end 58b that is connected to a drain (as discussed earlier) or a downstream growing chamber. When the growing chamber 22b is installed in a growing array 20b there is a negative slope from the first end 46b to the second end 58b that allows for runoff water from the drip system 42b and the sprayer system 54b to flow through the growing chamber 22b and be discharged to the drain or the next growing chamber in the growing array 20b. FIG. 6 shows an example of how three modular growing chambers 22b connected in series with an endcap 48b at the first end 46b of the first growing chamber 22b and the second growing chamber 22b connected to the second end 58b. A blower (not shown) could be connected to the endcap 48b to provide airflow to the roots of the plants growing in the row 24b.

In the embodiment shown, an access door 60b is installed in the growth channel 44b to access the cavity 56b. As best shown in FIG. 5, this access door 60b allows a user to access the cavity 56b and to inspect and replace the sprayer heads 52b and to also inspect the roots of the plants that would grow into the cavity as the plant grows in the growing chamber 22b.

The drip nozzle 40b connected to the drip system 42b is arranged to drip nutrient water into the plant container 36b, usually at the base of the plant above the root zone. The drip nozzle 40b is held in place with the attachment member 38b. The roots are sprayed with nutrient water from all angles by the one or more sprayer heads 52b within the growing chamber 22b from the sprayer system 54b. This creates a mist of water within the growth channel 44b. The number and location of the sprayer heads 52b may vary by whatever configuration is determined to be effective for the plant to be grown. The type of sprayer head 52b is interchangeable depending on the user preference or plant needs. Pressure regulators 62b are used throughout the system as required to adjust the water pressure to the sprayer heads 52b and drip nozzles 40b as needed. Shutoff valves 64b could be incorporated at the beginning of the drip system 42b and sprayer system 54b to selectively use one or both of the systems. Additional shutoff valves (not shown) could be incorporated at each sprayer head 52b and drip nozzle 40b to provide additional control to the water provided at each growing chamber 22b.

As the plant grows, so do its roots. The roots will expand down through the suspension chamber 32b and into the cavity 56b and eventually will lay in the nutrient water as it flows down the connected growing chambers 22b. The use of both the sprayer system 54b and the drip system 42b constantly will keep humidity at 100% in the chambers but constant use is not required. This configuration of the sprayer system 54b, the drip system 42b, and the cavity 56b that allows the roots to lay in the nutrient water flow combines aeroponics with drip irrigation and NFT in a single modular system.

The plant's roots are suspended in the growing chamber 22b. Multiple chambers can be combined into as many rows 24b as needed to fill the available space to create larger systems. The size and spacing of the growing chambers 22b are determined by the size of the plant that will be growing in it. For example, a head of lettuce might use an opening 34b that only has a 2-inch diameter with each opening 34b that is spaced 4-inches apart while tomatoes might use 6-inch diameter openings 34b spaced 24-inches apart.

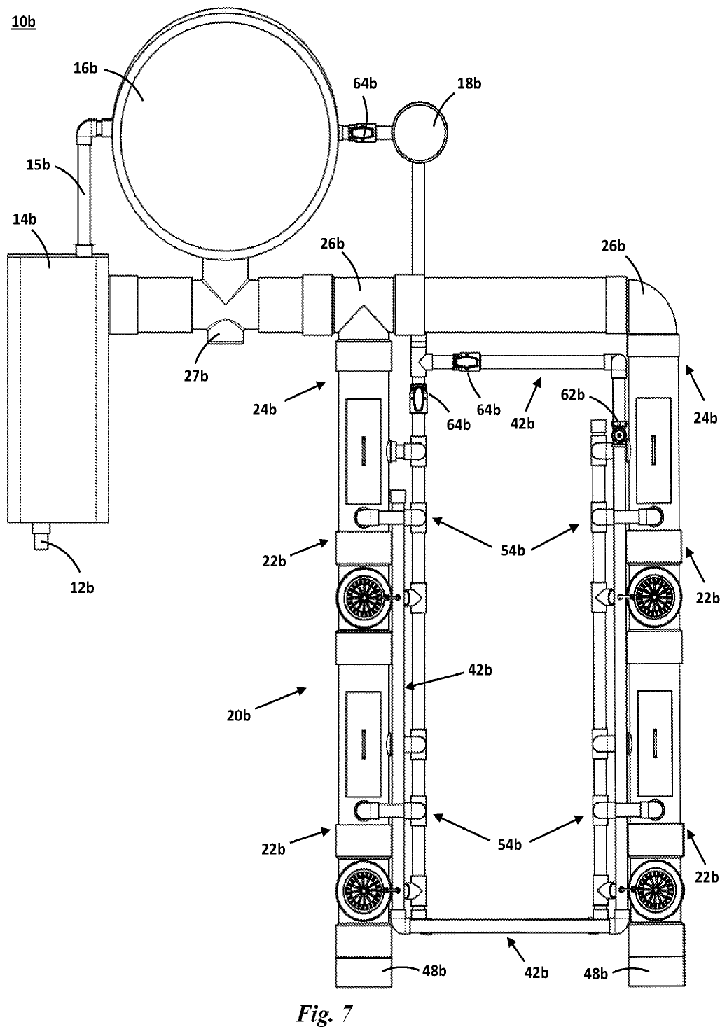

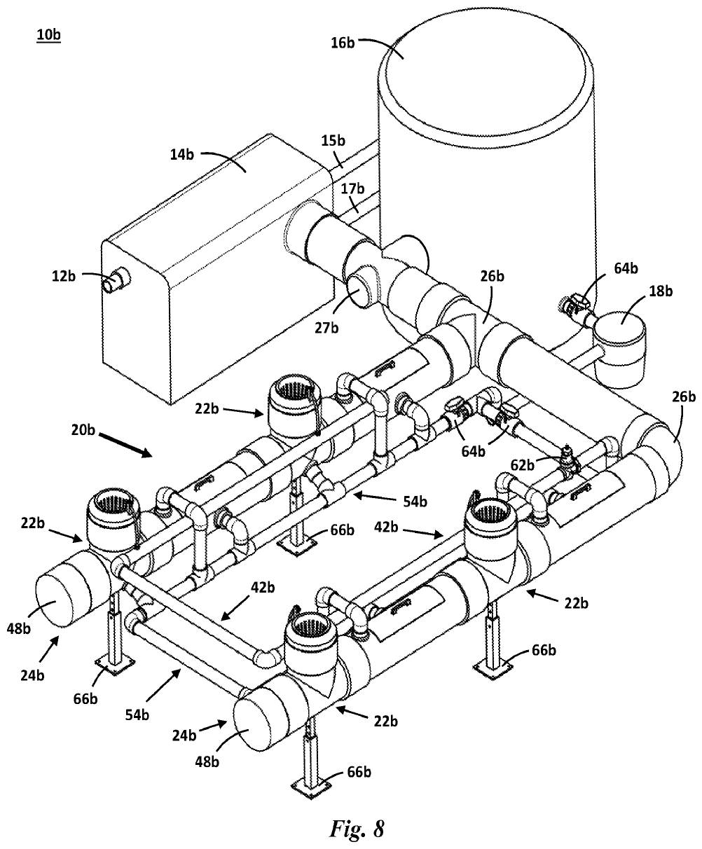

FIGS. 7 and 8 show views of a small horticulture system 10b that has a growing array 20b comprising two rows 24b having two growing chambers 22b each. A treatment system 14b is connected to the reservoir 16b. The sprayer system 54b and the drip system 42b are served by a pump 18b that is connected to the reservoir 16b. The growing chambers 22b are on a grade that allows the nutrient water to flow to the end of the rows 24b where they connect to the drain 26b where the water will be pumped or drained back to the reservoir 16b to be reused. The drain 26b is fitted with a switching valve 27b to allow the runoff water to be routed to the treatment system 14b rather than the reservoir 16b either periodically or as needed.

Conduit for the sprayer system 54b and the drip system 42b run alongside the interconnected growing chambers 22b with feeder lines branching to each individual growing chamber 22b. Adjustable support racks 66b or stands are installed under interconnected growing chambers 22b to set the sloping grade and hold the growing chambers 22b in place for water to gravity flow to the drain at the end of the row. Supplemental energy sources could be incorporated into the horticulture system 10b in case of power failures to prevent loss of crops.

To prevent roots clogging the growing chambers 22b, a channel may be incorporated to keep the water flowing. Viewports could also be incorporated to view the roots growing through the growing chambers 22b.

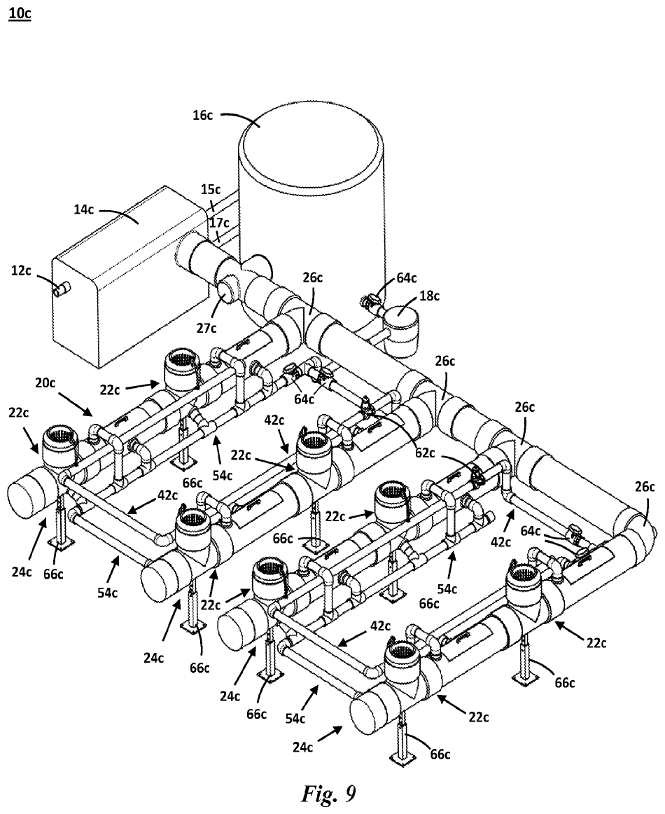

FIG. 9 is a variation of the horticulture system 10c showing a growing array 20c that comprises four rows 24c of two growing chambers 22c each. This illustrates the flexibility of the modular growing chambers 22c in custom growing arrays.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A horticulture system comprising:
a reservoir containing water;
a growing array comprising a plurality of modular growing chambers arranged in sequence in at least one row;
a sprayer system comprising at least one sprayer head to deliver water from said reservoir to each said growing chamber;
a drip system comprising at least one drip nozzle to deliver water from said reservoir to each said growing chamber;
each said growing chamber further comprising:
a suspension chamber with an opening to receive a plant and an attachment member above said opening for the mounting of one of said drip nozzles from said drip system; and
a growth channel located beneath said suspension chamber having a first end connected to an endcap or an upstream growing chamber, at least one opening for the insertion of one of said sprayer heads from said sprayer system, a cavity for the containment of plant roots, and a second end connected to a drain or a downstream growing chamber wherein there is a negative slope from said first end to said second end for the discharge of runoff water from said drip system and said sprayer system; and
said drain returns the runoff water from said drip system and said sprayer system to said reservoir.

2. The horticulture system of claim 1 further comprising an access door located on said growth chamber to access said cavity.

3. The horticulture system of claim 1 further comprising said growth channel having at least two said openings for the insertion of said sprayer heads from said sprayer system.

4. The horticulture system of claim 1 further comprising a treatment system connected to said reservoir.

5. The horticulture system of claim 1 further comprising:
a treatment system connected to said reservoir; and
said drain returns the runoff water from said drip system and said sprayer system to said treatment system before it is returned to said reservoir.

6. The horticulture system of claim 1 further comprising a flush tank connected to said growing array.

7. The horticulture system of claim 1 further adding oxygen to the water in said horticulture system by one of sprayers, oxygen stones, oxygen tanks, or a pump adding ambient air to said reservoir.

8. The horticulture system of claim 1 further comprising a nutrient injector connected to said reservoir for the addition of nutrients to the water.

9. The horticulture system of claim 1 further comprising a treatment system connected to said reservoir wherein said treatment system is one of an ozone treatment system, a UV treatment system, or a filtration system.

10. The horticulture system of claim 1 further comprising a supplemental energy source connected to said horticulture system.

11. The horticulture system of claim 1 further comprising a blower connected to said endcap for the provision of additional airflow through said growing array.

12. The horticulture system of claim 1 further comprising each said row of said growing array having a pressure regulator for independent control of said sprayer system and a pressure regulator for independent control of said drip system.

13. The horticulture system of claim 1 further comprising each said sprayer head having a shutoff valve.

14. The horticulture system of claim 1 further comprising each said drip nozzle having a shutoff valve.

15. The horticulture system of claim 1 further comprising a return pump located downstream of said growing array to return runoff water to said reservoir.

16. The horticulture system of claim 1 further comprising sensors to monitor the chemical and/or environmental conditions of the water and said growing chambers.

17. The horticulture system of claim 1 further comprising said plant container having a growing medium for the growth of contained plants.

18. The horticulture system of claim 1 further comprising said sprayer heads create a mist of water within said growth channel.

19. The horticulture system of claim 1 further comprising adjustable support racks for said growing array to set the slope of said growing chambers.

20. The horticulture system of claim 1 further comprising more than one said growing array.

21. A modular growing chamber for a horticulture system comprising:
a suspension chamber with an opening to receive a plant container and an attachment member above said opening for the mounting of a drip nozzle from a drip system; and
a growth channel located beneath said suspension chamber having a first end connectable to an endcap or an upstream growing chamber, at least one opening for the insertion of a sprayer head from a sprayer system, a cavity for the containment of plant roots, and a second end connectable to a drain or a downstream growing chamber.

22. The modular growing chamber of claim 21 further comprising an access door located on said growth chamber to access said cavity.

23. The modular growing chamber of claim 21 further comprising said growth channel having at least two said openings for the insertion of sprayer heads from the sprayer system.
